(19) United States
(12) Patent Application Publication
(10) Pub. No.: US 2025/0058479 A1
(43) Pub. Date: Feb. 20, 2025

(54) ROLLER PINCH GRIPPING DEVICE

(71) Applicant: Quest Industrial LLC, Monroe, WI (US)

(72) Inventor: Garret CRANDALL, Monroe, WI (US)

(21) Appl. No.: 18/807,408

(22) Filed: Aug. 16, 2024

Related U.S. Application Data
(60) Provisional application No. 63/520,193, filed on Aug. 17, 2023.

(51) Int. Cl. B25J 15/00

(52) U.S. Cl. CPC B25J 15/0028; B25J 15/0038

(57) ABSTRACT

A gripping device includes a first grip roller mounted for rotation about a first axis and having a first grip surface region facing outwardly from the first axis, and a second grip roller mounted for rotation about a second axis and having a second grip surface region facing outwardly from the second axis. An actuating system is configured for carrying out a grip operation that involves (i) rotating the first grip roller in a first rotational direction, in an end view along the first axis and the second axis, from a first standby position to a first film pinch position, and (ii) rotating the second grip roller in a second rotational direction, in the end view along the first axis and the second axis, form a second standby position to a second film pinch position, the second rotational direction being opposite the first rotational direction.

### TECHNICAL FIELD

This application relates generally to a device for gripping film and packages comprised of film and, more particularly, to a roller pinch gripping device.

### BACKGROUND

The standard solution for gripping the surface of a flexible film is to use a vacuum-based concept, such as a suction cup or suction pad. The gripping force of these methods is dependent on the flexibility, shape, texture, and adhesive nature of the interface between the film and cup/pad. Because there are so many variables at play, leakage commonly results, and is often highly variable, causing inconsistent holding force, and a poor ability to compensate for product variation, or wear/degradation to the system components. Secondarily, once a vacuum is established, the direction of forces transmitted at the interface between the cup and film can adversely affect the grip. For example, forces parallel to the plane of the interface between the cup/pad and film may act to peel off the cup/pad and increase leakage. Leakage also means that additional vacuum must be put into the system to maintain grip, and loss of energy supply can result in unintended release of the film.

It would be desirable to provide a gripping device that is better suited for consistently gripping film.

### SUMMARY

In one aspect, a gripping device includes a first grip roller mounted for rotation about a first axis, the first grip roller including a first grip surface region facing outwardly from the first axis, and a second grip roller mounted for rotation about a second axis that runs substantially parallel to the first axis, the second grip roller including a second grip surface region facing outwardly from the second axis. An actuating system is configured for carrying out a grip operation that involves (i) rotating the first grip roller in a first rotational direction, in an end view along the first axis and the second axis, from a first standby position to a first film pinch position, and (ii) rotating the second grip roller in a second rotational direction, in the end view along the first axis and the second axis, form a second standby position to a second film pinch position, the second rotational direction being opposite the first rotational direction.

In another aspect, a method of gripping a film-wrapped package unit involves: utilizing a gripping device with first and second grip rollers extending alongside each other; pressing the gripping device onto the film-wrapped package unit such that the first and second grip rollers engage first and second film regions of the film-wrapped package unit; and rotating the grip rollers in opposite directions to pull the first and second film regions into a zone between the grip rollers such that the first and second film regions are pinched together between the grip rollers.

In a further aspect, a gripping device includes of a pair of rollers, not necessarily of circular profile or constant radius, which can be actuated to rotate in opposite directions in a synchronous manner. The axes of rotation of the rollers may be fixed relative to each other, or they may be constrained so that both roller axes lie in a floating plane. This partially constrained configuration allows actuation of the axis of rotation of one or both rollers, so that controlled radial force may be applied between the rollers. In the configuration with fixed roller axes, similar radial forces are created and controlled by configuring the roller profiles and/or material selection for the roller surfaces. An example of this would be cladding the rollers in an elastic material and designing for interference between the rollers, so that the elasticity of the material creates radial forces in the plane containing both axes of rotation.

The rollers and the mechanism(s) that constrain and actuate them can perform the intended function by the following steps: (i) the device and film are brought into contact ensuring that both rollers make contact with the film, and some force is applied by both rollers to the film; (ii) the rollers are actuated so that they begin to rotate, such that tangential forces at the contact patches or areas between the film and rollers, act to push film material toward the region between the rollers; (iii) the tangential film movement causes a crease or creases to form in the material between the roller contact areas; (iv) as the rollers continue to rotate, the creased/bunched film is drawn up between the rollers and is pinched by radial forces between the rollers; (v) roller rotation stops, and the film is now retained by the radial clamping forces between the rollers. The film is released by reversing these steps.

The figures below show the progression of operation of the fixed-axis configuration where clamping forces come from roller elasticity and interference (note the roller overlap when rollers begin to contact each other):

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a perspective view of a gripping system with a movable arm and end-mounted gripping device;

FIGS. 2-3 show perspective views of the gripping device;

FIGS. 4-6 show end elevation, bottom and side elevation views of the gripping device;

FIG. 7 shows a perspective view of a roller body;

FIG. 8 shows the roller body with stiffening pin;

FIG. 9 shows a cross-section of the roller body with stiffening pin;

FIGS. 10-12 show views or portions of the gripping device;

FIG. 13 shows a partial perspective view of portions of the gripping device;

FIG. 14 shows a schematic view depicting forces acting on the grip rollers of the gripping device for operation;

FIGS. 15A-15B show a sequence of the gripping device engaging a film-wrapped package unit;

FIGS. 16A-16D show a sequence of the gripping device engaging and pulling in film regions of a film-wrapped package unit;

FIG. 17 shows an axial end view of one roller body of the gripping device; and

FIG. 18 shows an axial end view of one roller body in an embodiment of the gripping device in which the grip roller axes are movable during gripping operations.

### DETAILED DESCRIPTION

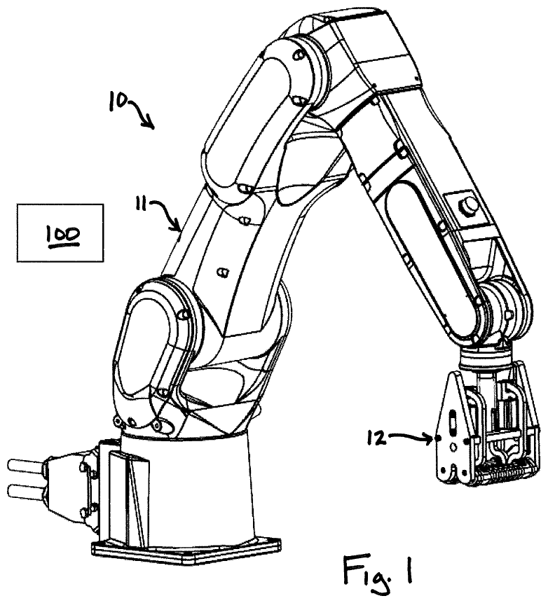

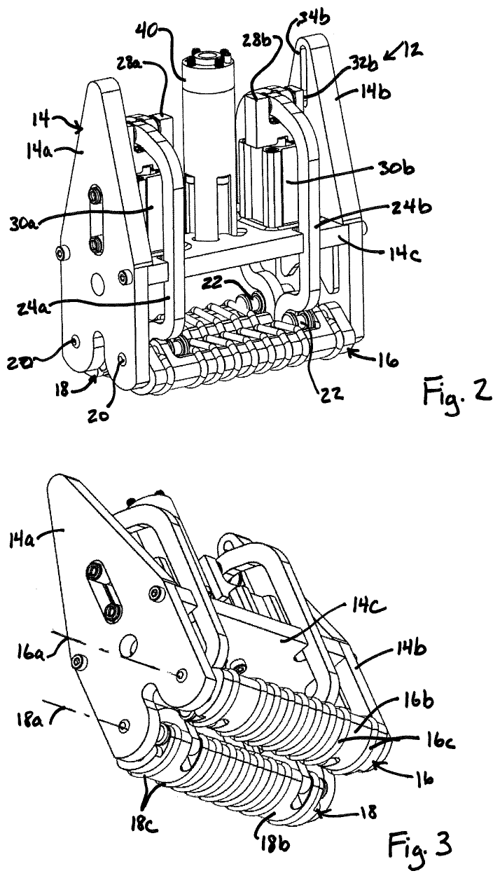

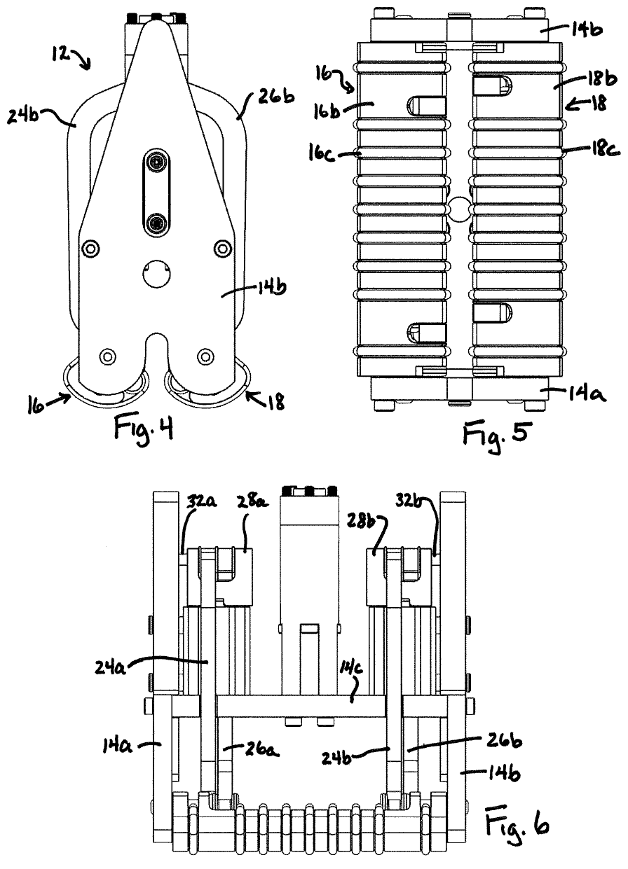

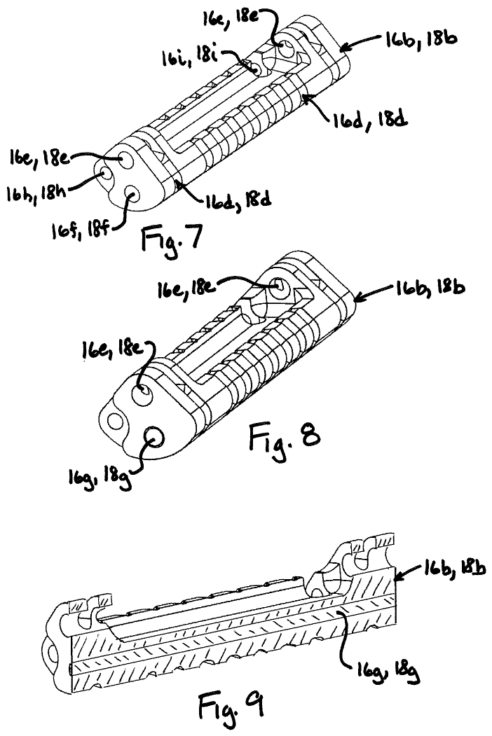

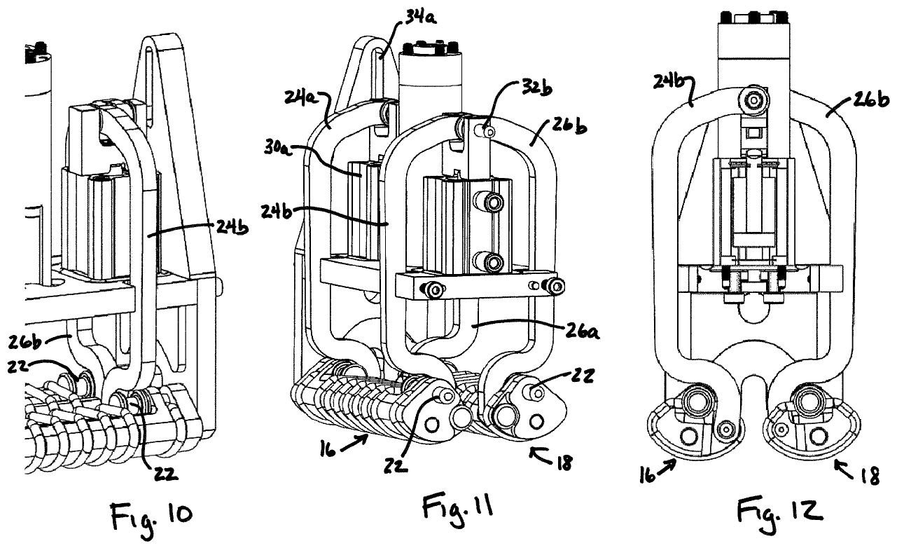

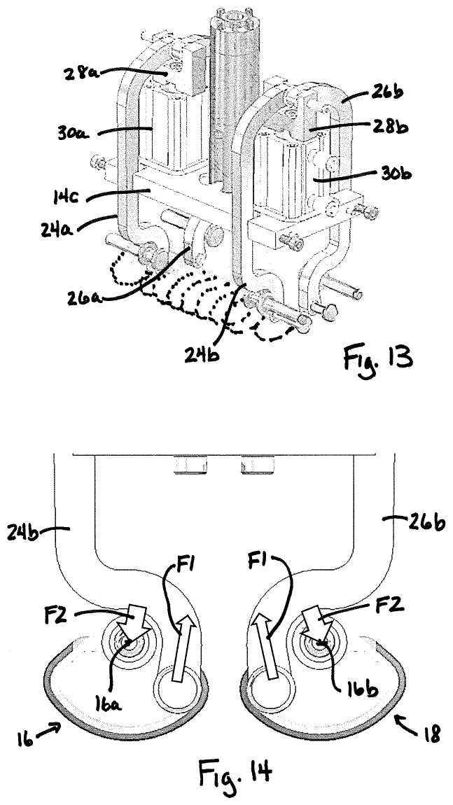

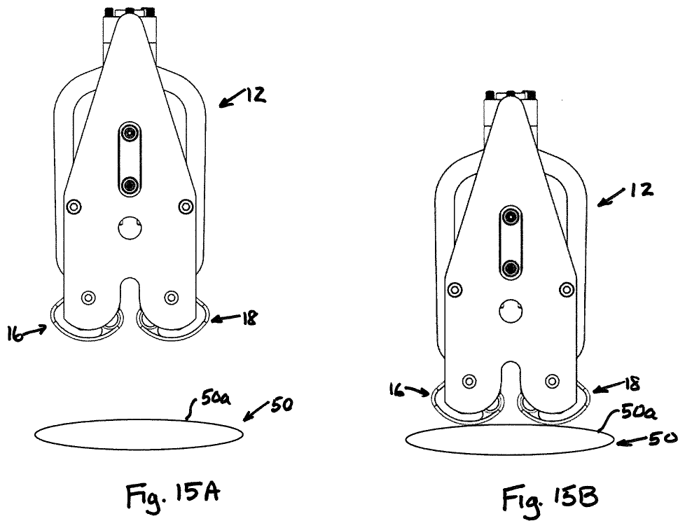

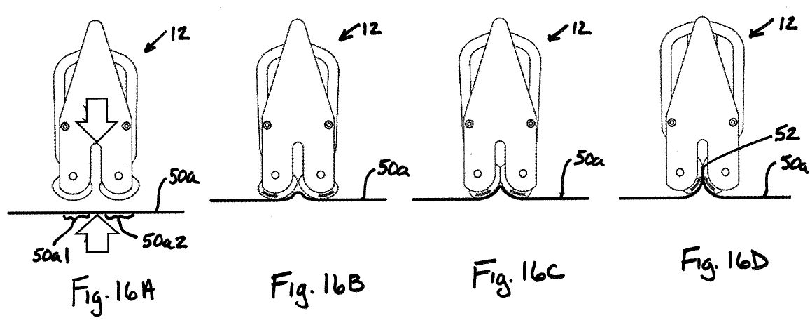

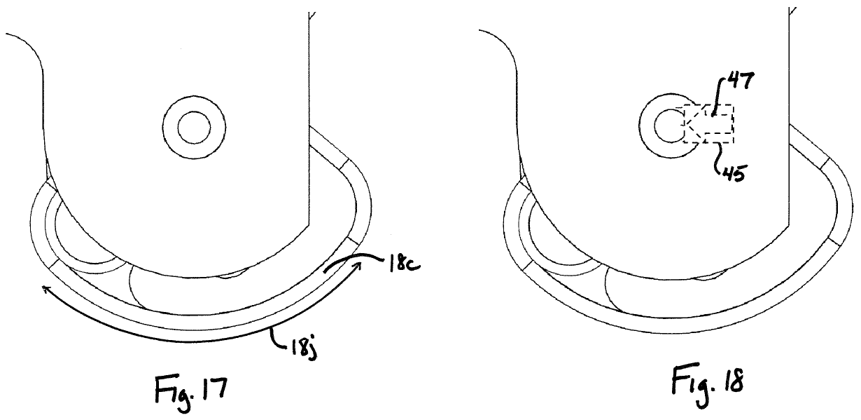

Referring to FIGS. 1-18, a gripping system 10 includes a movable arm unit 11 (e.g., a robotic arm or other) having a gripping device 12 connected at the end of the movable arm unit. Typically, the gripping system 10 may be positioned and set up to, for example, pick film-wrapped package units from one location (e.g., a conveyor) and move the film-wrapped package units to another location (e.g., another conveyor, a pallet, a carton or case, or any other location).

The gripping device 12 includes a frame structure 14 formed by end plates 14a, 14b and lateral plate 14c interconnecting the end plates. Grip rollers 16, 18 are also mounted between the end plates 14a, 14b for rotation about respective axes of rotation 16a, 18a. Here, each grip roller 16, 18 is comprised by a respective roller body 16b, 18b having a plurality of respective elastomeric grip bands 16c, 18c disposed therearound and spaced apart along the length of the roller body. Each roller body 16b, 18b may include a plurality of recessed regions 16d, 18d into which portions of the grip bands 16c, 18c seat for retaining the grip bands at the desired positions along the length of the roller body. The elastomeric grip bands form grip surface regions of the grip rollers. Each roller body 16b, 18b also includes respective axial end openings 16e, 18e that receive respective end pins 20, 22 for pivotable mounting of the rollers to the end plates. Each roller body also includes an axial opening 16f, 18f that receives a respective stiffening pin 16g, 18g that extends along the full length of the body for added stiffening of the roller bodies. Exemplary materials for the roller bodies could be UHMW PE or acetal resin, but metals or other materials could also be used, in some implementations.

Each roller body also includes respective axial openings 16h, 18h and 16i, 18i to which respective actuating linkages 24a, 26a and 24b, 26b are pivotably connected. In this regard, the upper ends of linkages 24a and 26a are connected to a bracket 28a, and the upper ends of linkages 24b, 26b are connected to a bracket 28b. Bracket 28a is linearly movable via linear actuator 30a, and bracket 28b is linearly movable via linear actuator 30b. Linear actuators 30a and 30b may, for example, be pneumatic actuators and, here, are mounted on the lateral plate 14c. Each bracket includes a respective guide pin 32a, 32b that slides along a respective end plate slot 34a, 34b for the purpose of assuring stable movement of the bracket and, in some cases, such that the upper end and/or lower end of the slot defines the limit(s) of movement of the bracket. The guide pins 32a, 32b also define the pivot axes for the upper ends of the linkages.

Each grouping of a linear actuator, associated bracket and pair of linkage arms defines an actuating system for effecting rotation of the grip rollers. Per FIG. 14, the forces in the linkages create a couple with the reaction at the roller axis pins, so that torque is created about the roller axes. Arrows F1 represent the tension in the linkages, acting through the eccentric pins connecting the linkages to the rollers, and arrows F2 are the reactions at the roller axis pins. Because the links are symmetrical, and each linear actuator drives movement of both a linkage associated with grip roller 16 and a linkage associated with grip roller 18, the rotation of the grip rollers will be synchronous and the resultant forces at the pneumatic actuator rods are coaxial with the rods. A mount post 40 extends from the lateral plate 14c for mounting of the gripping device 12 to the arm 11.

FIGS. 15A-15B show movement of the gripping device 12 into engagement with a film-wrapped package unit 50 with surrounding film 50a, with the grip rollers 16 and 18 in respective standby positions. Per the sequence of FIGS. 16A-16D, the grip rollers are rotated in a gripping operation in which the grip rollers start in the standby positions (e.g., FIG. 16A) and are rotated (e.g., per FIGS. 16B-16d) into film pinch (or sheet pinch) positions (e.g., final pinch position shown in FIG. 16D) that sequentially pull the film up into the zone between the grip rollers 16, 18. In particular, when the grip rollers 16, 18 are engaged on a surface of the film 50a while respectively in the standby positions, and the actuating system then carries out the gripping operation, the grip surface regions of the grip rollers interact with the surface of the film to pull the film into the zone between the grip rollers. As the actuating system carries out the grip operation, the grip surface regions of the grip roller 16 pull a first film portion 50a1 into the zone and the grip surface regions of the grip roller 18 pull a second film portion 50a2 into the zone, such that the first film portion and the second film portion come together at abutting face portions with the first film portion and the second film portion joined by a crease or fold 52 in the film. The folded/creased film portion is thereby held in a clamped manner between the two grip rollers. The film, and associated film-wrapped package unit, can be released (a release operation) by simply operating the actuating systems to rotate the grip rollers in the opposite direction to move the film out of the zone between the grip rollers.

In the illustrated embodiment, the grip rollers 16, 18 are cooperatively configured (here, both out of round profiles in axial end view) such that a spacing between the first grip surface region and the second grip surface region becomes smaller duration rotation of the grip rollers the film pinch positions.

In order to carry out the gripping operation, a controller 100 may be provided for the gripping system 10. In embodiments, the controller 100 is connected and configured for moving the movable arm and for activating the actuating system, and the controller is configured to move the arm such that the grip roller 16 and the grip roller 18, when in their standby positions, are engaged onto a film-wrapped package unit 50 with at least a predetermined force before the actuating system(s) is/are activated to carry out the grip operation that moves the grip rollers to their film pinch positions. This predetermined force may be a setting that is established based upon the characteristics (e.g., size, type of film, contents) of the film-wrapped package unit 50 to be gripped (e.g., according to testing). For this purpose, the arm 11 may include on-board force sensor(s) that provide feedback regarding the force with which the gripping device 12 is being pressed against the film-wrapped package unit.

As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device or the control functions of any component thereof.

Exemplary advantages provided, at least in some cases, by the above-described gripping device(s) include: (1) successful gripping depends on fewer variables when compared to vacuum-base solutions, so the roller-pincher is more tolerant of film and process variance, (2) grip strength is less affected by the direction of forces applied to the film, because tension forces applied anywhere in the film are transmitted to shear forces in the contact patch/area between the rollers and film, whereas the application of film tensions in vacuum-based solutions can have different affects depending on how they are applied.; (3) reduced energy consumption as the gripper only consumes energy when actively actuated, it has negligible energy consumption when maintaining state (i.e., when the rollers are not being moved), whereas, in most cases, vacuum-based solutions require constant energy input to overcome leakage.

In the illustrated embodiment, the main grip surface regions (e.g., 18j) of the grip rollers may have surface profiles that create desired film pull and pinch characteristics. In the described configuration with fixed grip roller axes, similar radial pinch forces are created and controlled by design of the grip roller profiles and/or material selection for the grip surface regions. An example of this would be cladding the rollers in an elastic material and designing for interference between the rollers, so that the elasticity of the material creates radial pinch forces in the plane containing both axes of rotation. For example, the elastomeric bands 16c, 18c may be aligned with each other such that when the grip rollers 16, 18 are rotated for gripping, the bands 16c, 18c will, in the absence of film, come into engagement with each other, with the resiliency of the bands creating the pinch forces therebetween.

Per FIG. 18, in other embodiments, one or both of the grip rollers may be mounted such that the grip roller axes are shiftable during the gripping operation (e.g., along a mount slot 45) and a biasing mechanism 47 (e.g., a spring member or material) may be provided to urge the grip rollers toward each other, with the biasing mechanism allowing shift of the grip roller axes to shift when the interacting forces of the engaging grip rollers overcome the bias force. The biasing mechanism 47 could also be a powered device.

The contemplated gripping devices may, in embodiments, be well suited to gripping film-wrapped package units in which the film has a thickness of between 0.002″ and 0.012″. Exemplary film types include polyamide, polyethylene, polyester, polypropylene, and a range of coextruded, laminated, and hybrid types.

It is to be clearly understood that the above description is intended by way of illustration and example only, is not intended to be taken by way of limitation, and that other changes and modifications are possible. For example, the actuating system(s) for the grip rollers may take on a variety of forms (e.g., motor driven linear actuators, or end mounted drive motor(s) that are geared to the grip rollers to achieve the desired grip roller rotation). Although the illustrated grip rollers are not in contact with each other when in the standby position, in alternative embodiments, portion of the grip rollers may be in contact with each other when the grip rollers are in the standby position (e.g., embodiments with shifting grip roller axes may be particularly suited to this configuration). Moreover, in some implementations or uses, the roller gripping device could be used to grip flexible sheet materials other than films, such as natural or synthetic textiles. While the above embodiment shows grip rollers that are out of round (i.e., non-circular in end profile view), embodiments in which the grip rollers are circular in end profile are also possible.

1. A gripping device, comprising:
a first grip roller mounted for rotation about a first axis, the first grip roller including a first grip surface region facing outwardly from the first axis;
a second grip roller mounted for rotation about a second axis that runs substantially parallel to the first axis and is spaced away from the first axis, the second grip roller including a second grip surface region facing outwardly from the second axis;
an actuating system configured for carrying out a grip operation that involves (i) rotating the first grip roller in a first rotational direction, in an end view along the first axis and the second axis, from a first standby position to a first film pinch position, and (ii) rotating the second grip roller in a second rotational direction, in the end view along the first axis and the second axis, form a second standby position to a second film pinch position, the second rotational direction being opposite the first rotational direction.

2. The gripping device of claim 1, wherein, when the first grip roller and the second grip roller are engaged on a surface of a film while respectively in the first standby position and the second standby position, and the actuating system then carries out the grip operation, the first grip surface region and second grip surface region interact with the surface of the film to pull the film into a zone between the first grip roller and the second grip roller.

3. The gripping device of claim 3, wherein, as the actuating system carries out the grip operation, the first grip surface region pulls a first film portion into the zone and the second grip surface portion pulls a second a second film portion into the zone, such that the first film portion and the second film portion come together at abutting face portions with the first film portion and the second film portion joined by a crease or fold in the film.

4. The gripping device of claim 1, wherein the actuating system comprises at least one linear actuator that moves a first link that is pivotably connected to the first grip roller and a second link that is pivotably connected to the second grip roller.

5. The gripping device of claim 4, wherein the at least one linear actuator comprises a pneumatic actuator.

6. The gripping device of claim 1, wherein the first grip roller and second grip roller are mounted such that a spacing between the first axis and the second axis is fixed.

7. The gripping device of claim 1, wherein at least the first grip roller is mounted such that a spacing between the first axis and the second axis is variable during the gripping operation.

8. The gripping device of claim 7, wherein the first grip roller is biased toward the second grip roller.

9. The gripping device of claim 1, wherein:
the first grip roller comprises a first roller body with at least one first elastomeric grip band portion thereon for defining the first grip surface region;
the second grip roller comprises a second roller body with at least one second elastomeric grip band portion thereon for defining the second grip surface region.

10. The gripping device of claim 1, wherein the first grip roller and the second grip roller are mounted to a frame structure.

11. The gripping device of claim 1, wherein the first grip roller and the second grip roller are cooperatively configured such that a spacing between the first grip surface region and the second grip surface region becomes smaller duration rotation of the first grip roller and the second grip roller to the first film pinch position and the second film pinch position.

12. A gripping system, comprising a movable arm unit and the gripping device of claim 1 mounted to the arm unit for movement therewith.

13. The gripping system of claim 12, further comprising:
a controller configured for moving the movable arm and for activating the actuating system, wherein the controller is configured to move the arm such that the first grip roller and the second grip roller, when respectively in the first standby position and the second standby position, are engaged onto a film wrapped product with at least a predetermined force before the actuating system is activated to carry out the grip operation that moves the first grip roller to the first film pinch position and the second grip roller to the second film pinch position.

14. A method of gripping a film-wrapped package unit, comprising:
utilizing a gripping device with first and second grip rollers extending alongside each other;
pressing the gripping device onto the film-wrapped package unit such that the first and second grip rollers engage first and second film regions of the film-wrapped package unit;
rotating the grip rollers in opposite directions to pull the first and second film regions into a zone between the grip rollers such that the first and second film regions are pinched together between the grip rollers.
